(19) United States
(12) Patent Application Publication
(10) Pub. No.: US 2015/0039481 A1
(43) Pub. Date: Feb. 5, 2015

(54) SERVICE UTILIZATION BROWSER PLUG-IN

(71) Applicants: Henning Els, Petaluma, CA (US); Phil Fine, Petaluma, CA (US); Ari Sodhi, Petaluma, CA (US)

(72) Inventors: Henning Els, Petaluma, CA (US); Phil Fine, Petaluma, CA (US); Ari Sodhi, Petaluma, CA (US)

(73) Assignee: Calix, Inc., Petaluma, CA (US)

(21) Appl. No.: 13/959,490

(22) Filed: Aug. 5, 2013

(51) Int. Cl. G06Q 30/04

(52) U.S. Cl. CPC G06Q 30/04
USPC 705/34

(57) ABSTRACT

A method of using a data monitoring service may include transmitting a request for subscriber billing status information; in response to the request, receiving the subscriber billing status information in a response message; formatting a status message based in part on the received subscriber billing status information, the status message including an estimated cost for a billing cycle of the subscriber; and presenting the status message in a network application.

### BACKGROUND

In various examples, consumers use a service provider to connect to a network. For example, the consumer may pay a subscription fee for a billing period to obtain access to the Internet. In some examples, the subscriber may have a limit to how much data may be used for the billing period. Additionally, the subscriber may be responsible for an overage fee if the subscriber goes over the data limit during the billing period.

### TECHNICAL FIELD

This patent document pertains generally to monitoring data usage, and more particularly, but not by way of limitation, to a service utilization browser plug-in.

### BRIEF DESCRIPTION OF DRAWINGS

Some embodiments are illustrated by way of example and not limitation in the figures of the accompanying drawings in which:

FIG. 1 is a schematic view of a computer network system according to various examples.

FIG. 2 is a block diagram of a data usage plugin, according to various examples.

FIG. 3 illustrates a web browser interface, according to various examples.

FIG. 4 illustrates an example user interface associated with a data usage plugin.

FIG. 5 is a flowchart of an example method of presenting a status message, according to various examples.

FIG. 6 is a flowchart of an example method of transmitting a response message, according to various examples.

FIG. 7 is a block diagram of a machine in the example form of a computer system within which a set instructions may be executed for causing the machine to perform any one or more of the methodologies discussed herein.

### DETAILED DESCRIPTION

The following detailed description includes references to the accompanying drawings, which form a part of the detailed description. The drawings show, by way of illustration, example embodiments. These embodiments, which are also referred to herein as “examples,” are described in enough detail to enable those skilled in the art to practice aspects of the inventive subject matter. In this document, the terms “a” or “an” are used, as is common in patent documents, to include one or more than one. In this document, the term “or” is used to refer to a nonexclusive or, unless otherwise indicated.

In various examples, a subscriber (e.g., a household, a company, etc.) may have a network access plan with a service provider. The network access plan may have a bandwidth cap, be metered, or a combination of the two. For example, the subscriber may have a limit on the amount of data allowed to be consumed (i.e., used) for a given billing period (e.g., a month). The limit may be tiered such that there is a base amount of data for the billing period and then an overage charge for data used over the base amount. In an example, the overage charges are structured as a per unit charge for data usage over the base amount such as charging $10 dollars per each additional 100 GB regardless of how far over the subscriber has gone or charging a per-byte overage charge. Other payment structures may be used without departing from the scope of the disclosure. In various examples, a subscriber account may have one or more devices (e.g., computers, phones, etc.) that count towards the metered data.

Because of the tiered nature of a plan, a subscriber may want to know how much data has been used across the subscriber's devices during a billing period. Additionally, the subscriber may want to know an estimate of the current bill including applicable overage charges, as appropriate. In order to determine a current data usage, the subscriber may log in to a status webpage provided by the subscriber's service provider (e.g., an ISP); however, if the subscriber does not log in, the subscriber may unknowingly go over the base amount for a billing period. In various embodiments, the subscriber may download a network usage program that presents the current data usage of the subscriber or an estimated bill for the current billing period. Various aspects of the network usage program are described herein.

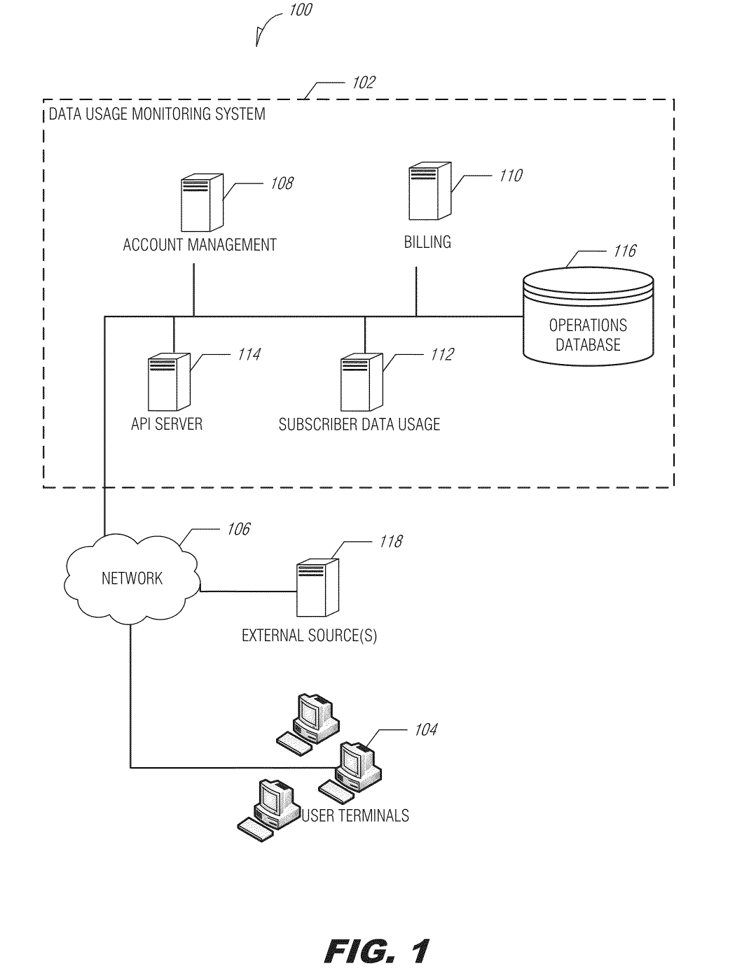

FIG. 1 is a schematic view of a computer network system 100, according to various examples, which may be used to display a network usage status message to a subscriber. Computer network system 100 includes data usage monitoring system 102 and user terminals 104, communicatively coupled via network 106. In an example, data usage monitoring system 102 includes account management server 108, billing server 110, and subscriber data usage server 112, and application programming interface (API) server 114, communicatively coupled to operations database 116. Data usage monitoring system 102 may be implemented as a distributed system. For example, one or more elements (e.g., servers, databases) of data usage monitoring system 102 may be located separately from other elements. Additionally, while servers 108-114 are illustrated as distinct servers, functionality described herein may be performed by as a single server. Similarly, the illustrated servers 108-114 may represent a group of two or more servers, cooperating with each other, provided by way of a pooled, distributed, or redundant computing mode. In various example, the different servers are operated by different entities.

Network 106 may include local-area networks (LAN), wide-area networks (WAN), wireless networks (e.g., 802.11 or cellular network), the Public Switched Telephone Network (PSTN) network, ad hoc networks, personal area networks (e.g., Bluetooth) or other combinations or permutations of network protocols and network types. The network 106 may include a single local area network (LAN) or wide-area network (WAN), or combinations of LAN's or WAN's, such as the Internet. The various devices coupled to network 106 may be coupled to network 106 via one or more wired or wireless connections.

Discussed below is various functionality of servers 108-114 and data that may be stored on these servers. As illustrated, data usage monitoring system 102 includes operations database 116. In various examples, servers 108-114 may store some or all of their data on operations database 116. Operations database 116 may be composed of one or more logical or physical databases. For example, operations database 116 may be viewed as a system of databases that when viewed as a compilation, represent an “operations database.” Sub-databases in such a configuration may include an account database, a billing database, and a data usage database. Operations database 116 may be implemented as a relational database (e.g., SQL), a non-relational database (e.g., NoSQL), a centralized database, a distributed database, an object oriented database, or a flat database in various embodiments.

In various examples, account management server 108 stores management account information for one or more subscribers. For example, for each subscriber, account management server 108 may store one or more of the following: a contact name of the account, an account identifier (e.g., an alphanumeric sequence), a billing contact for the subscriber, and a payment method. In various examples, an access level for the subscriber may also be stored on account management server 108. The access level may indicate what details level of the current data usage the subscriber is permitted to access. For example, one level of access may permit the subscriber to access the current number of bytes used in a billing cycle, whereas another level of access may allow the subscriber to access a current billing estimate.

In various examples, the access level and account information may be changed via a program executing on account management server 108 or via an external software program accessing the data on account management server 108 (e.g., a web-based interface or thin-client executing on a computing device separate from account management server 108). In other words, an account administrator, such as an employee of a service provider offering network access, may update account and access information for one or more subscribers as needed. After changes are made, a storage device (e.g., operations database 116) may be updated based on the changes.

In various examples, billing server 110 stores billing data for subscribers of a service provider. The billing data may be used to calculate what each subscriber is billed for a billing period or estimate a bill based on past or current data trends of the subscriber. For example, billing server 110 may store a start-date and an end-date for each subscriber with respect to a billing period.

Additionally, the billing data may include billing rate information for each subscriber of a service provider (e.g., an ISP). The billing rate information may include a base rate (e.g., $50) and a base amount of data allowed to be consumed for the base rate (e.g., 250 GBs). The billing rate information may also include an overage rate that may be used to calculate an overage charge for a subscriber and how the overage is to be calculated (e.g., prorated or tiered). There may be more than one overage rate per subscriber (e.g., $1 dollar for the first 10 GBs and then $2 dollars for each additional 10 GBs). In various examples, a subscriber does not have a base amount, but instead is billed per byte or data size. The billing data may be stored with a reference to the same subscriber identification as used in account management server 108. Other billing arrangements may also be used without departing from the scope of this disclosure.

To calculate what a subscriber currently owes for a billing cycle, according to various examples, billing server 110 may use the following process. Billing server 110 may request the current data usage for the subscriber from subscriber data usage server 112. The retrieved data usage may be compared to the base amount of data allowed in a billing cycle for the subscriber. If the data usage is at or below the base amount, the bill may be calculated as the base rate. If the data usage is above the base amount, the difference (e.g., data used over the base amount) may be used to calculate the overage charge. Therefore, the amount due for a subscriber may be the sum of the base rate and a calculated charge.

In an example, instead of or in addition to a current billing estimate, a subscriber may wish to know an estimate of what his or her bill would be by the end of the cycle, also referred to as a future billing estimate. For example, while a subscriber may know that he or she is not over a byte limit, the subscriber may find it helpful to know if he or she is on track to exceed the byte limit and an estimate of what any overage charges may be. In various examples, operations database 116 may store past data usage of the subscriber. The past data usage may include how bytes have been used for past billing cycles, averages over one or more time periods (e.g., average data usage per billing cycle over the past three billing cycles), and an average byte usage for the current billing cycle (e.g., 500 MB/day). The past data usage may be used in estimating the future billing estimate.

In various examples, a future billing estimate may be determined in a number of different ways. For example, the average byte usage for the current billing cycle may be retrieved and extrapolated to the end of the billing cycle to estimate how many bytes may be used by the end of the billing cycle using a formula such as:

(current data usage)+[(average of current data usage/day)×(number of days remaining in billing cycle)]

In another example, instead of using the average bytes/day of the current billing cycle, various estimates by be calculated using past data usage of previous billing cycles. For example, a high estimate may use the highest per-day average data usage for a billing cycle over the past X billing cycles, a low estimate may use the lowest per-day average, and an average estimate may use the per-day average. Accordingly, a subscriber may be shown a range of possible future bills for the current billing cycle.

In various examples, data usage and billing estimates may be broken down by type. For example, within a home there may two laptops, a gaming console, and a media streamer. The subscriber may wish to know how much each device has cost in the past and estimates of how much a device may cost in the future and change usage behavior (e.g., rent movies as opposed to stream movies).

In various examples, subscriber data usage server 112 stores the current data usage of the subscriber of a service provider. In an example, “current” means the latest information available with respect to the data usage of a subscriber. This may mean that there is a lag time between when a subscriber has used data (e.g., watched a movie) and when subscriber data usage server 112 determines that the user has used the data. In various examples, “current” data is approximately accurate within 10 minutes of the data use, but other levels of accuracy may be used (e.g., one minute, one hour). In various examples, a per device break down of data usage for a subscriber is stored in subscriber data usage server 112.

In various examples, subscriber data usage server 112 determines the current data usage. For example, subscriber data usage server 112 may use NetFlow packets or other traffic monitoring technology (e.g., SFLOW®) to determine traffic statistics for a subscriber and devices of a subscriber. In some examples, a subscriber may have more than one IP address/port—this data may be stored in account management server 108. Accordingly, subscriber data usage server 112 may aggregate data usage across all IP addresses/port for a subscriber. In various examples, subscriber data usage server 112 does not analyze the traffic of the subscriber to determine the current data usage, but instead receives the information from an external source periodically or on a rolling basis. In an example, subscriber data usage server 112 stores the current data usage of a subscriber and associates the data usage with the account identifiers of the subscriber.

In various examples, the current data usage may be based on the data used by user terminals 104. A user terminal may be a computing device that is granted access to a network (e.g., the Internet) by paying for a subscription to a service provider. User terminals 104 may be, but are not limited to, desktop computers, laptops, tablets, or mobile devices. In an example, not all data usage for each device counts towards a plan with the service provider. Instead, in an example, only data usage that originates from the device while the device is associated (directly or indirectly) with an IP address/port associated with a subscriber may count towards the data usage. For example, if the subscriber is a residential home and the user terminal is a laptop, data consumed by the laptop outside the residence would not count towards the current data usage.

In various examples, API server 114 responds to requests for current billing usage data and estimated bills. In an example, API server 114 is configured as a web service (e.g., a web based API) that responds to requests from computing devices. For example, API server 114 may define a set of request methods such as HTTP GET, HTTP POST, etc., that may be used to interact with data stored in data usage monitoring system 102. The API may be defined in variety of ways, including, but not limited to the Simple Object Access Protocol (SOAP) and Representational State Transfer (REST) architecture. In response to a request message, API server 114 may format a response message and transmit it back to the requester. In various examples, the response message is formatted according to a defined structure such Extensible Markup Language (XML) or JavaScript Object Notation (JSON). Further details of which request methods and response messages are used by API server 114 are discussed in greater detail below. While discussed as an API, other request and response paradigms may also be used.

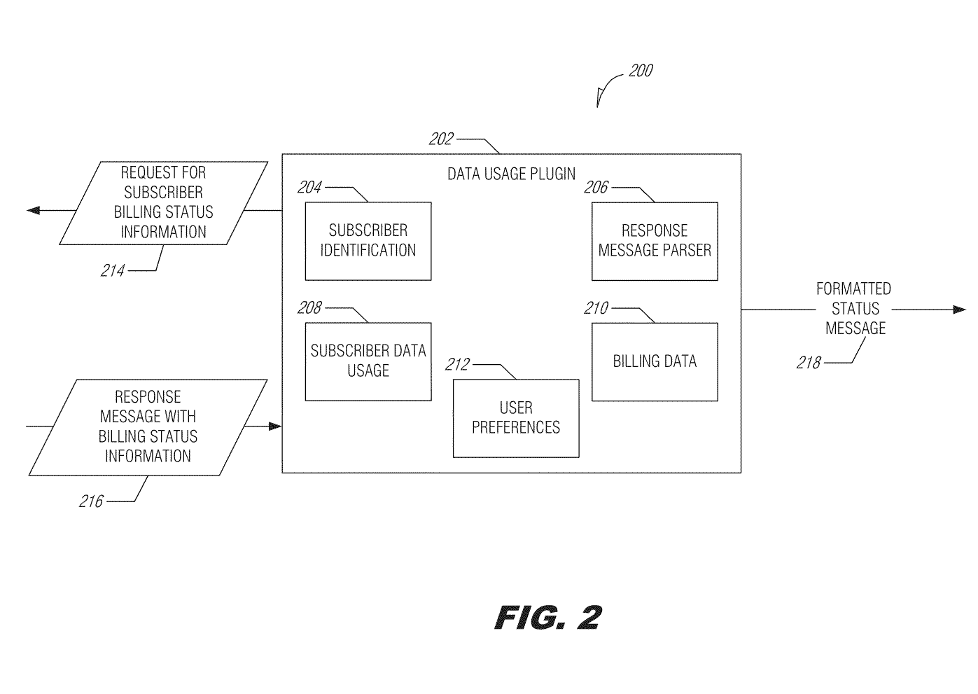

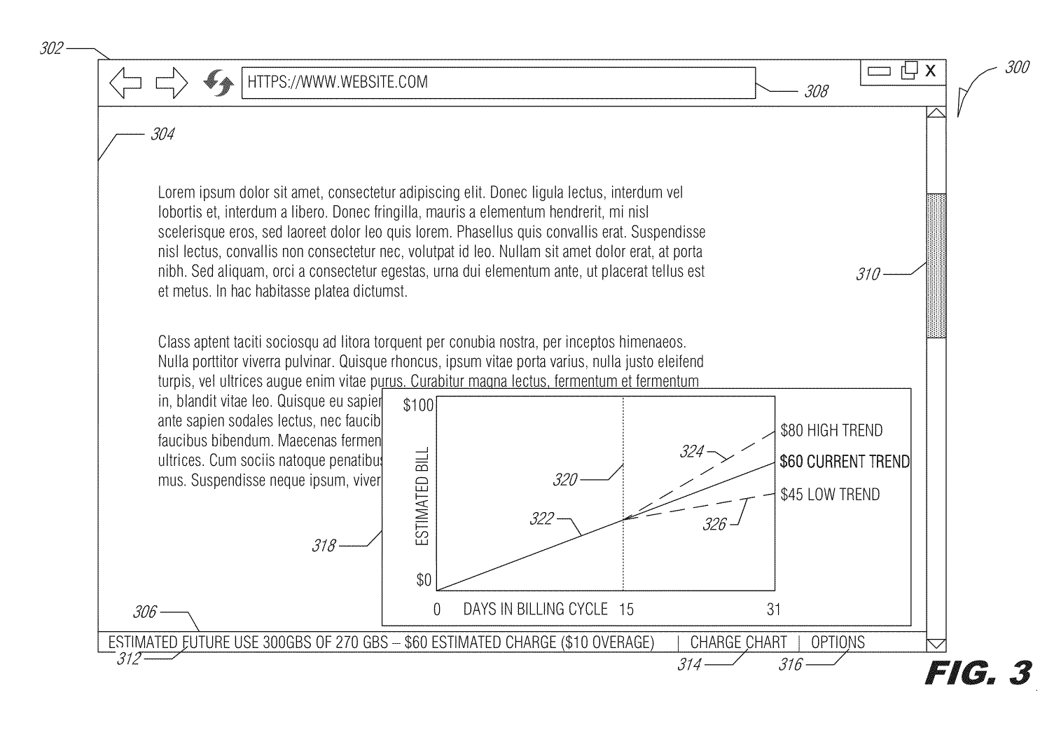

FIG. 2 illustrates an example block diagram 200 of data usage plugin 202. In various examples, a plugin is a set of instructions that are executable by a processor and configure the processor to perform a set of operations. In some examples, the plugin may provide additional functionality to an existing software program. For example, data usage plugin 202 may be a plugin that runs as part of a web browser on a user terminal. FIG. 3 illustrates an example of output that may be generated by a plugin and presented in a web browser.

Further illustrated in FIG. 2 are components of data usage plugin 202, in an example: subscriber identification 204; response message parser module 206, subscriber data usage 208, billing data 210, and user preferences 212. Additionally illustrated is subscriber billing status information request 214, response message 216, and formatted status message 218. In various examples, data usage plugin 202 is the application that communicates with data usage monitoring system 102 (FIG. 1). More specifically, in an example, data usage plugin 202 communicates with API server 114 to obtain subscriber data usage and billing data for a subscriber.

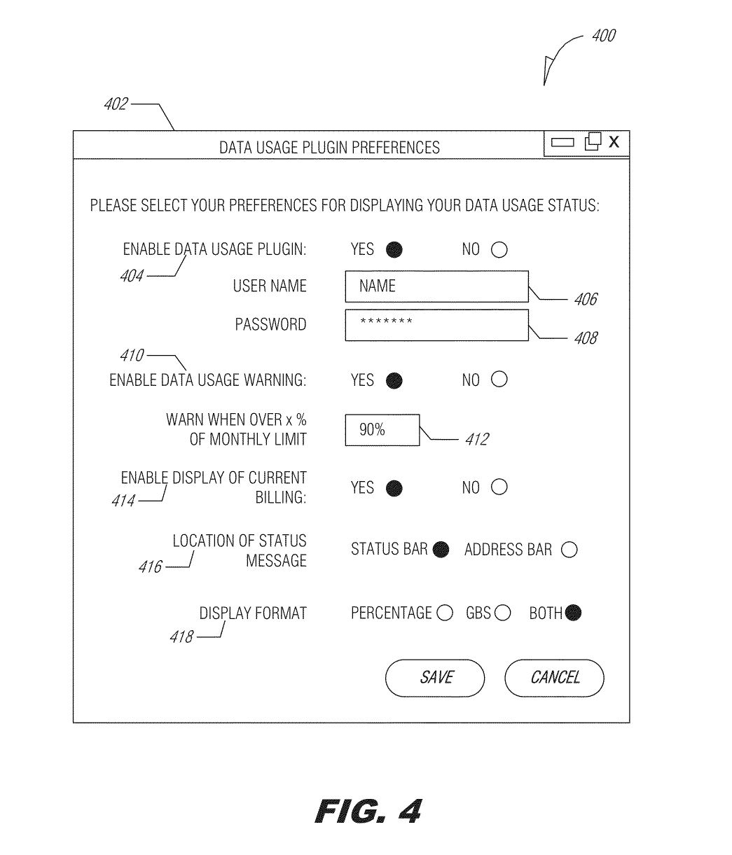

In various examples, data usage plugin 202 may be downloaded by a user and installed on one or more computers. In an example, data usage plugin 202 is preconfigured with subscriber identification 204. For example, data usage plugin 202 may be made available on a website of the service provider. A subscriber may log in to the website using credentials (e.g., an account identifier number or user name, etc.), and, before download begins of plugin 202, subscriber identification 204 may be configured as the account identifier of the subscriber. In an example, subscriber identification 204 is configurable via a user preference user interface such as discussed in FIG. 4.

In various examples, data usage plugin 202 may format billing status information request 214 according to a format defined by API server 114. Request 214 may include a subscriber identification such as an account number or a username and password pair. Request 214 may further include what data is being requested. For example, request 214 may ask for the current data usage or an estimated bill for the current billing cycle. In various examples, communications between data usage plugin 202 and data usage monitoring system 102 are secure, authenticated, and private according to techniques known to persons of ordinary skill in the art (e.g., using public-key infrastructure, hypertext transfer protocol secure, etc.).

In response to request 214, response message 216 may be received according to a format specified by API server 114, such as a specific XML schema. In an example, response message parser 206 parses the response message to retrieve the requested data. For example, response message 216 may include fields/sections for a subscriber's current data usage, an estimation of the current bill, device specific usage, and errors that may have resulted from request 214 (e.g., the request was refused due to insufficient access rights).

In an example, subscriber data usage 208 and billing data 210 are updated based on the contents of response message 216. For example, billing data 210 may be updated to include various future billing estimates, as discussed above. In various examples, data usage plugin 202 also outputs formatted status message 218 based on data stored in data usage plugin 202 and user preferences 212 as discussed further herein. Formatted status message 218 may be in text form (e.g., text status 312 in FIG. 3) or may be a graphical representation (e.g., chart 318 in FIG. 3)

FIG. 3 illustrates a web browser interface 300, according to various examples. Web browser interface 300 includes toolbar 302, display area 304, status area 306, address bar 308, scroll element 310, text status 312, charge chart element 314, options element 316, graphical status 318. As can be seen, in an example, both text status 312 and graphical status 318 may be distinct from content in display area 304. In other words, a user may browse multiple websites but continue to see statues 312 and 318.

In an example, a user may activate options element 316 by clicking or hovering over element 316. A menu may then be displayed to a user with selectable options that include user preferences for data usage plugin 202. In an example, instead of charge chart element 314 being listed in status bar 306, it may appear in a menu of options element 316.

In an example, graphical status 318 includes billing cycle indicator 320, current trend line 322, high trend line 324, and low trend line 326. Billing cycle indicator 320 may indicate the relative position within a billing cycle. As illustrated in FIG. 3, the current billing cycle is on day 15 of a 31 day cycle. Trend lines 322-326 may represent three future billing estimates as received in a response message (e.g., response message 216). Data included in graphical status 318 may be changed based on user preferences. For example, instead of a future billing estimate, a current billing estimate may be shown. In an examples, high and low trend lines 324, 326 may not be shown.

In various examples, graphical status 318 may be hidden until a user action occurs. For example, a user may hover a cursor over charge chart element 314 to have graphical status 318 appear. In an example, after a predetermined amount of time (e.g., 10 seconds) graphical status 318 may disappear. In an example, if a user places a cursor outside of graphical status 318, graphical status 318 may also disappear. In various examples, a user may set a preference to have graphical status 318 appear when the user is on-track to exceed a certain dollar amount for a billing cycle. Thus, in various examples, usage plugin 202 may display various status messages to a user indicating how much data a subscriber has used and/or billing estimates according to user preferences set in plugin 202.

FIG. 4 illustrates an example user interface 400 associated with a data usage plugin. User interface 400 may allow a user to enter preferences and credential information for obtaining and displaying data usage and billing status/estimates of a subscriber. User interface 400 may appear after a user selects a user preference menu element presented after activation of options element 316.

In various examples, user interface 400 includes preference window 402, enabling preference 404, user name input form 406, password input form 408, data usage warning preference 410, data warning limit 412, current billing preference 414, location of status message preference 416, and display format preference 418. While interface 400 generally relates to preferences of a web browser plugin, similar preferences may be used for other implementations of a data usage application. For example, a user may run a background application that resides in the taskbar or menu of an operating system. In such instances, preferences related to such implementations may be used instead of browser-specific preferences (e.g., status bar). Values entered into user interface 400 may be stored with a data usage plugin (e.g., user preferences 212).

In various examples, the value (e.g., yes/no) of enabling preference 404 determines whether or not to display usage statistics to a user. In an example, if the value of the enabling preference is no, the remaining preferences presented in preference window 402 may be disabled. Values entered into user name input form 406 and password input form 408 may be used to identify a subscriber to data usage monitoring system 102 when requesting a current data usage. While a username and password are illustrated in interface 400, other types of identification may be used such as an account identification (e.g., an account number).

In various examples, additional preferences may be set by a subscriber. For example, instead of a single threshold as illustrated in FIG. 4, a user may enable multiple thresholds. Additionally, alert thresholds may be based on an estimated future billing instead of a current billing. For each threshold, a user may also set an action/alert to take when the threshold is reached. Actions may include, but are not limited to, presenting a dialog box to a user, changing the format of status message (e.g., color, size, font), presenting a graphical status message, texting a phone number, e-mailing, etc. Accordingly, a user may set a first threshold at 75% and an action of presenting a dialog box, and then set a second threshold at 110% with an action of e-mailing an address of a subscriber—the e-mailed address may be different than a current user of the browser. Multiple actions may be set for each threshold. In various examples, per device thresholds may also be set.

In various examples, user preferences may also be set for a format of a graphical status message such as illustrated in FIG. 3. These preferences may be set in the same user interface as a textual status message or on a separate interface. The graphical status preferences may include, but are not limited to, how many months of data to use in calculating a trend line of past data usage, whether to use high/low trend lines based on past data usage, and format preferences for any presented chart.

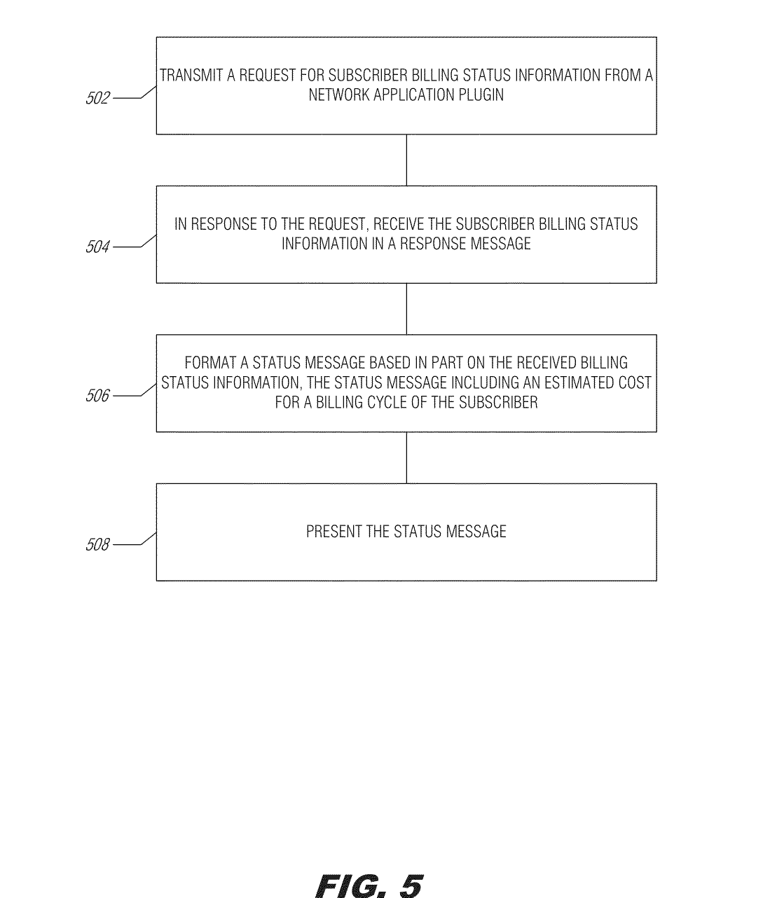

FIG. 5 is a flowchart of an example method of presenting a status message, according to an example. The method may be performed using various components or modules as described herein. For example, the method may be performed by configuring at least one processor of a computing device.

In an example, a request for subscriber billing status information is transmitted from a network application plugin (operation 502). The request may be transmitted to an API server. In an example, the network application plugin may be a plugin for an internet browser. The request may include subscriber identification information such as a username and password or an account identifier. The request may also identify which types of subscriber billing status information are being requested. For example, the request may be for a combination of current billing estimate, one or more future billing estimates, device specific billing information, base charges, overage charges, and dates of a billing cycle. In an example, the request is encrypted. In various examples, the request is periodically transmitted (e.g., every 5 minutes) to the API server. In an example, more than one request is sent to retrieve the billing status information. In an example, the request includes an API key.

In various examples, in response to the request, subscriber billing status information is received in a response message (operation 504). The response message may be parsed to retrieve the individual pieces of information requested. For example, the response message may be parsed to retrieve the base charge amount and a current billing estimate. The parsed information may be stored in the network application plugin. In an example, the response message may include an error when one or more pieces of information could not be retrieved due to access restrictions for unavailability of the data.

In various examples, a status message may be formatted based in part on the received billing status information, wherein the status message includes an estimated cost for a billing cycle of the subscriber (operation 506). For example, user preferences for the status message may be retrieved from the network application. The user preferences may indicate how to present any received billing status information. For example, a user may indicate to have the billing status information be a textual status message presented in a status bar of a browser such that a current billing estimate is presented (e.g., displayed). In an example, the user preferences may indicate to present a graphical status message that includes trend lines of a future billing estimate. In another example, the user preferences may indicate that the status message is to include device-specific billing break-downs. Accordingly, depending on the user preferences, the relevant pieces of data may be retrieved and a status message may be generated and presented to a subscriber (operation 508) in a network application such as an internet browser. In various examples, when a new response message is received, such as in response to a periodic request, the status message may be updated.

In various examples, when a response message is received, the network application may check if any user defined thresholds have been reached or exceeded based on previous user preferences. If a threshold has been reached or exceeded, the network application may implement the action associated with the preference. For example, consider a threshold that indicates that when a current billing estimate is over $60, a dialog alert is to be presented. When the response message is received, the response message may be parsed to determine if the current billing estimate is over $60. If so, a dialog box may be presented to a user. In various examples, a thresholds may not be associated with a displayed status message. For example, a user may indicate that the status message only include an estimated byte usage, but a threshold may still be defined that is based on an estimated dollar amount.

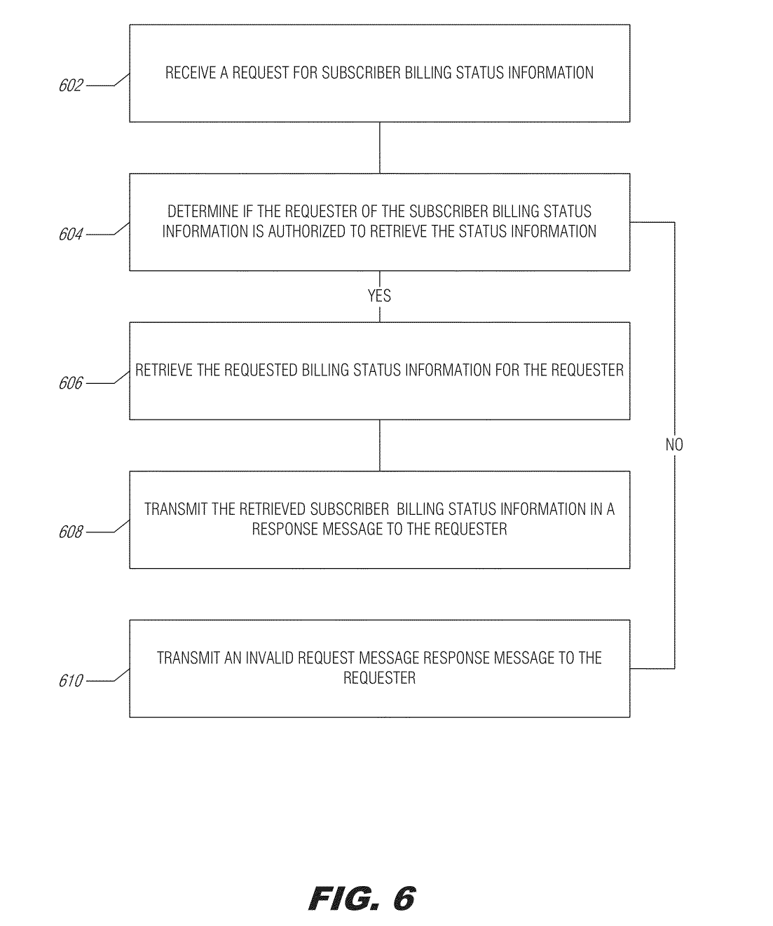

FIG. 6 is a flowchart of an example method of transmitting a response message, according to an example. The method may be performed using various components or modules as described herein. For example, the method may be performed by configuring at least one processor of a computing device.

In various examples, a request is received for a subscriber billing status information (operation 602). The request may include subscriber identification information such as a user name and password or an account identifier. The request may also identify which types of subscriber billing status information are being requested. For example, the request may be for a combination of current billing estimate, one or more future billing estimates, device specific billing information, base charges, overage charges, and dates of a billing cycle. In an example, the request includes an API key that may be checked to determine if the requester is an authorized requester that may use an API provided by the API server.

In various examples, it is determined if the requester of the subscriber billing status information is authorized to retrieve the status information (operation 604). For example, the request may be received at an API server of a data usage monitoring system. The included subscriber identification may be used to determine a level of access for the subscriber (i.e., whether or not a subscriber has access to the requested billing usage information).

For example, if a username and password are used, the API server may transmit a request to an account management server to determine the level of access. The account management server may check if the included password is correct for the user name, and if so, map the user name to an account. Then, the level of access may be retrieved for the account and transmitted back to the API server. In various examples, a single server may be used as the API server and account management server.

Accordingly, if the requester's level of access, as indicated by an account management server, is sufficient, the requested billing status information may be retrieved for the requester (operation 606); otherwise, an invalid request response message may be transmitted back to the requester (operation 610). In various examples, to retrieve the requested information, the API server may send requests to different servers. For example, to obtain billing cycle information such as start and end dates as well as how a bill is calculated with a subscriber, the API server may transmit a request to a billing server with the subscriber identification information. Similarly, the API server may transmit a request to a subscriber data usage server with the subscriber identification to obtain current or past data usage.

In various examples, after retrieving data from one or more servers, API may perform additional calculations as needed based on the information requested. For example, the API server may calculate a current estimated bill using current byte usage retrieved from the subscriber data usage server and billing calculation methods retrieved from the billing server as well as a range of future estimated bills using trend data. Upon completing any calculations, a response message may be formulated and transmitted back to the requester including the retrieved subscriber billing status information (operation 608).

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

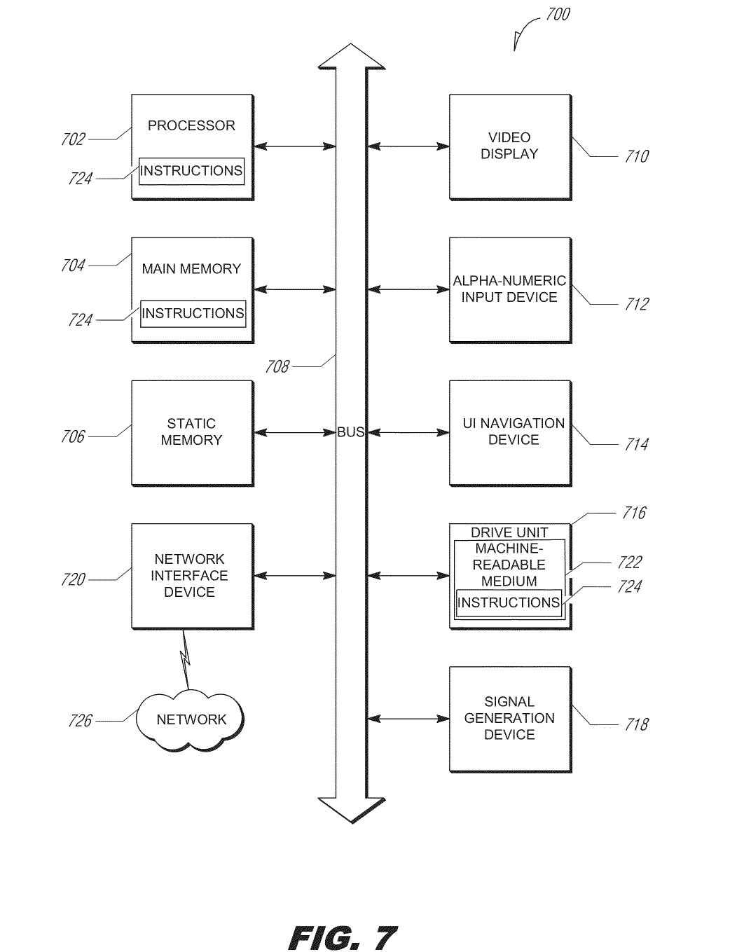

FIG. 7 is a block diagram of a machine in the example form of a computer system 700 within which instructions 724 may be executed for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU) or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an alphanumeric input device 712 (e.g., a keyboard), a user interface (UI) navigation device 714 (e.g., a mouse), a disk drive unit 716, a signal generation device 718 (e.g., a speaker) and a network interface device 720.

The disk drive unit 716 includes a machine-readable medium 722 on which is stored one or more sets of instructions and data structures (e.g., software) 724 embodying or utilized by any one or more of the methodologies or functions described herein. The instructions 724 may also reside, completely or at least partially, within the main memory 704 and/or within the processor 702 during execution thereof by the computer system 700, the main memory 704 and the processor 702 also constituting machine-readable media.

While the machine-readable medium 722 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

The instructions 724 may further be transmitted or received over a communications network 726 using a transmission medium. The instructions 724 may be transmitted using the network interface device 720 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the inventive subject matter. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method comprising:
transmitting a request for subscriber billing status information;
in response to the request, receiving the subscriber billing status information in a response message;
formatting a status message based in part on the received subscriber billing status information, the status message including an estimated cost for a billing cycle of the subscriber; and
presenting the status message in a network application.

2. The method of claim 1, further comprising:
parsing the response message to determine a base charge amount; and
parsing the response message to determine a billing estimate for the billing cycle of the subscriber.

3. The method of claim 2, further comprising:
changing the format of the status message when the billing estimate for the billing cycle is over the base charge amount by a threshold amount.

4. The method of claim 1, further comprising:
periodically transmitting the request for the subscriber billing status information; and
updating the status message based on subscriber billing status information received in response to the periodically transmitted request.

6. The method of claim 1, wherein the status message is displayed in a web browser and is displayed separate from content of a web page.

7. The method of claim 1, wherein the request for subscriber billing status information includes a subscriber identification.

8. The method of claim 1, further comprising:
storing a plurality of billing thresholds; and
alerting a user each time a billing threshold of the plurality of billing thresholds is reached or passed.

9. A computer-readable storage device comprising instructions, which when executed by at least one processor, configure the at least one processor to:
transmit a request for subscriber billing status information;
in response to the request, receive the subscriber billing status information in a response message;
format a status message based in part on the received subscriber billing status information, the status message including an estimated cost for a billing cycle of the subscriber; and
present the status message in a network application.

10. The computer-readable storage device of claim 9, wherein the at least one processor is further configured to:
parse the response message to determine a base charge amount; and
parse the response message to determine a billing estimate for the billing cycle of the subscriber.

11. The computer-readable storage device of claim 10, wherein the at least one processor is further configured to:
change the format of the status message when the billing estimate for the billing cycle is over the base charge amount by a threshold amount.

12. The computer-readable storage device of claim 9, wherein the at least one processor is further configured to:
periodically transmit the request for the subscriber billing status information; and
update the status message based on subscriber billing status information received in response to the periodically transmitted request.

13. The computer-readable storage device of claim 9, wherein the status message is displayed in a web browser and is displayed separate from content of a web page.

14. The computer-readable storage device of claim 9, wherein the status message includes a future estimated billing for the billing cycle.

15. A system comprising:
a storage device comprising instructions;
at least one processor to execute the instructions, wherein the at least one processor is configured to:
transmit a request for subscriber billing status information;
in response to the request, receive the subscriber billing status information in a response message;
format a status message based in part on the received subscriber billing status information, the status message including an estimated cost for a billing cycle of the subscriber; and
present the status message in a network application.

16. The system of claim 15, wherein the status message includes data identifying data usage of devices associated with the subscriber during the billing cycle.

17. The system of claim 15, wherein the status message is formatted as a percentage indicating a ratio of data usage of the subscriber during the billing cycle to allowed data usage of the subscriber for the billing cycle.

18. The system of claim 15, wherein the status message is a graphical status message indicating a range of possible future billing estimates.

19. The system of claim 15, wherein the request for the subscriber usage information includes a subscriber identification.

20. The system of claim 15, wherein the request includes an application protocol interface key.
